(19) United States
(12) Patent Application Publication
(10) Pub. No.: US 2014/0345722 A1
(43) Pub. Date: Nov. 27, 2014

(54) EMULSION-PRODUCING HYDRAULIC CIRCUIT AND METHOD FOR RE-EMULSIFYING A SEPARATED LIQUID

(71) Applicant: Charles D. Markert, Purcellville, VA (US)

(72) Inventor: Charles D. Markert, Purcellville, VA (US)

(73) Assignee: CAVITRONIX CORPORATION, Front Royal, VA (US)

(21) Appl. No.: 14/343,991

(22) PCT Filed: Sep. 10, 2012
(86) PCT No.: PCT/US2012/054438

§ 371 Date: May 23, 2014

Related U.S. Application Data
(60) Provisional application No. 61/532,953, filed on Sep. 9, 2011.

(51) Int. Cl. B01F 5/10; B01F 3/08

(52) U.S. Cl. CPC B01F 5/102; B01F 3/088
USPC 137/565.35

(57) ABSTRACT

The present invention relates to an emulsion-producing hydraulic circuit. The hydraulic circuit includes a by-pass loop comprising a first end and a second end, where the first end of the by-pass loop and the second end of the by-pass loop are connected to a supply line of the hydraulic circuit before and after a pump. The asynchronous by-pass loop also includes a control valve, and the by-pass loop transfers a portion of an emulsion and/or any separated liquid that has accumulated in the hydraulic circuit to the supply line to be re-emulsified. Also disclosed is a method for re-emulsifying a separated liquid present in a hydraulic circuit.

This application claims the benefit of U.S. Provisional Patent Application Ser. No. 61/532,953, filed Sep. 9, 2011, which is hereby incorporated by reference in its entirety.

### FIELD OF THE INVENTION

The present invention relates to an emulsion-producing hydraulic circuit and a method for re-emulsifying a separated liquid present in a hydraulic circuit.

### BACKGROUND OF THE INVENTION

Emulsion fuels have been shown to have environmental and, in some cases, cost benefits over basic fuel oil. Installing, measuring, and/or controlling, inflows of fuels and water and, in some cases, chemical additives, into cavitational and other mechanical blenders and emulsifiers as well as outflows of fuel-oil emulsion (“FOE”) is currently uncertain with existing FOE technology, because existing FOE devices are not easily integrated into the existing combustion engine, turbine, or boiler system.

Installation and control of inflows and outflows of water emulsions, including FOE systems, could be improved by development of an easy-to-install “plug and play” device. Simplifying the installation and use of fuel emulsification devices, improving the remixing of separated water and, therefore, protection from de-emulsified water could greatly improve the existing technology.

A number of processes and devices are already in use creating emulsions, including water-in-fuel emulsions, both mechanically and through use of chemical additives. The challenge in existing FOE technology and certain other emulsions is that the water portion of un-stabilized emulsions, including water-in-oil FOE, which is created for use in burners, boilers, turbines, and combustion engines, begins to separate naturally when the emulsifying system stops operating during shut-downs. The result of this flow stoppage and natural gravitational force is to leave an accumulation of de-emulsified water in the lowest physical places in the hydraulic circuit. This is true even in applications providing for re-circulation of the water and substance to be emulsified.

De-emulsified accumulations in the hydraulic circuit that are injected into a burner, boiler, turbine, or combustion engine (or elsewhere) could cause damage or unintended results. Thus, there is a need to ensure proper re-emulsification of these de-emulsified accumulations, to prevent these accumulations from circulating in the hydraulic circuit upon re-start of the system. There is a need for a system and method for de-emulsified mixtures to be proactively re-emulsified to protect against potential disruption in the emulsification process and to prevent damage caused by the presence of a separated, de-emulsified slug of water. This water slug, if not re-emulsified but injected as plain water into the boiler, could quench a flame and potentially damage fire tubes or combustion chambers, or if injected into a combustion engine could damage the piston and/or other critical engine parts. It is crucial to get the water re-emulsified as quickly as possible.

All hydraulic systems have a return line (sometimes referred to as a by-pass line) that may or may not have a pressure relief valve for flow and pressure relief in case of unexpected or expected blockage. However, an additional controllable, constant operating asynchronous by-pass that would eliminate a slug of water that would otherwise continue to exist and be circulated through the hydraulic circuit has not been described.

The present invention is directed to overcoming the deficiencies in the art.

### SUMMARY OF THE INVENTION

One aspect of the present invention relates to an emulsion-producing hydraulic circuit comprising an intake port for receiving at least two liquids; a supply line comprising a first end and a second end, wherein the first end of the supply line is connected to the intake port to receive and transport the at least two liquids; a pump positioned in the supply line to create flow of the at least two liquids through the hydraulic circuit; an emulsion-producing device positioned in the supply line and capable of forming an emulsion of the at least two liquids; a fitting connected to the second end of the supply line, where the fitting receives the emulsion and transfers (i) a first portion of the emulsion from the hydraulic circuit to a combustion site and (ii) a second portion of the emulsion to a return line, where the return line comprises a first end and a second end, the first end of the return line being connected to the fitting and the second end of the return line being connected to the supply line upstream from the pump; and a by-pass loop comprising a first end and a second end, where the first end of the by-pass loop and the second end of the by-pass loop are connected to the supply line on either side of the pump, said by-pass loop further comprising a control valve, and where said by-pass loop transfers a portion of the emulsion and/or any separated liquid that has accumulated in the hydraulic circuit to the supply line to be re-emulsified.

Another aspect of the present invention relates to a method for re-emulsifying a separated liquid present in a hydraulic circuit. This method involves providing the hydraulic circuit of the present invention and opening the valve to permit flow of a portion of the emulsion and/or any separated liquid that has accumulated in the hydraulic circuit to the supply line to be re-emulsified.

The present invention is in the technical field of emulsions, including FOE and other emulsions, where oil or other substances in liquid form and water are to be combined.

As described herein, the present invention relates to a hydraulic circuit comprising an asynchronous loop to skim off a portion of any slug of water existing in the hydraulic circuit and inject it into the return line where the emulsion is being continuously returned. This asynchronous by-pass loop, which is nested within the normal supply/return line, also serves as a redundant, or back-up, by-pass function, increasing pump seal protection as well as enabling asynchronous remixing of water back into an emulsion.

Moreover, the present invention simplifies installation and operation of water emulsions, including FOE systems. For example, in one embodiment where it is physically possible to do so, all piping circuits may be bored into a single block of metal or other water and fuel resistant material with all necessary components mounted to or affixed thereon. A single block creates an easily maintainable and operational system that simplifies the device operation and care ensuring it can continue to be used for the purposes intended, including the reduction of basic fuel oil consumed and reduction of pollution created by the combustion process.

### BRIEF DESCRIPTION OF THE DRAWINGS

FIG. 1 is a schematic illustration showing one embodiment of the emulsion-producing hydraulic circuit of the present invention.

FIG. 2 is a schematic illustration showing one embodiment of the emulsion-producing hydraulic circuit of the present invention where the emulsion-producing hydraulic circuit is formed into a single manifold block.

FIG. 3 is a schematic illustration of one embodiment of the emulsion-producing hydraulic circuit of the present invention linked to a fuel rail in a diesel engine.

### DETAILED DESCRIPTION OF THE INVENTION

The present invention relates to an emulsion-producing hydraulic circuit comprising an intake port for receiving at least two liquids; a supply line comprising a first end and a second end, wherein the first end of the supply line is connected to the intake port to receive and transport the at least two liquids; a pump positioned in the supply line to create flow of the at least two liquids through the hydraulic circuit; an emulsion-producing device positioned in the supply line and capable of forming an emulsion of the at least two liquids; a fitting connected to the second end of the supply line, where the fitting receives the emulsion and transfers (i) a first portion of the emulsion from the hydraulic circuit to a combustion site and (ii) a second portion of the emulsion to a return line, where the return line comprises a first end and a second end, the first end of the return line being connected to the fitting and the second end of the return line being connected to the supply line upstream from the pump; and a by-pass loop comprising a first end and a second end, where the first end of the by-pass loop and the second end of the by-pass loop are connected to the supply line on either side of the pump, said by-pass loop further comprising a control valve, and where said by-pass loop transfers a portion of the emulsion and/or any separated liquid that has accumulated in the hydraulic circuit to the supply line to be re-emulsified.

As used herein, the term “hydraulic circuit” refers to a system comprising an interconnected set of discrete components that transport liquid. The hydraulic circuit controls where fluid flows and fluid pressure within the hydraulic circuit. The hydraulic circuit includes passive components, such as a network of tubes, hoses, transmission lines, or channels through which liquid flows. The hydraulic circuit also includes active components, such as pumps.

As used herein, an “emulsion” means one liquid (referred to as the dispersed phase) dispersed in another liquid (referred to as the continuous phase). Thus, references to a “mixture” to be emulsified are intended to mean a mixture with two or more liquid heterogeneous components that can form an emulsion or colloid which may also contain liquid or gas components as well. In one embodiment, the at least two liquids comprise water and oil, and the emulsion is a water-in-fuel emulsion.

The physical properties of an emulsion can vary. For example, according to one embodiment, the dispersed phase emulsion droplets have a size range of about 1 to 20 microns, or about 2 to 10 microns. In one particular embodiment, e.g., for water (the dispersed phase) in fuel (the continuous phase) emulsions, emulsion droplets have a range of about 2-10 microns. At this range, the amount of hydrocarbon fuel used to produce heat for industrial and other production and propulsion applications can be reduced.

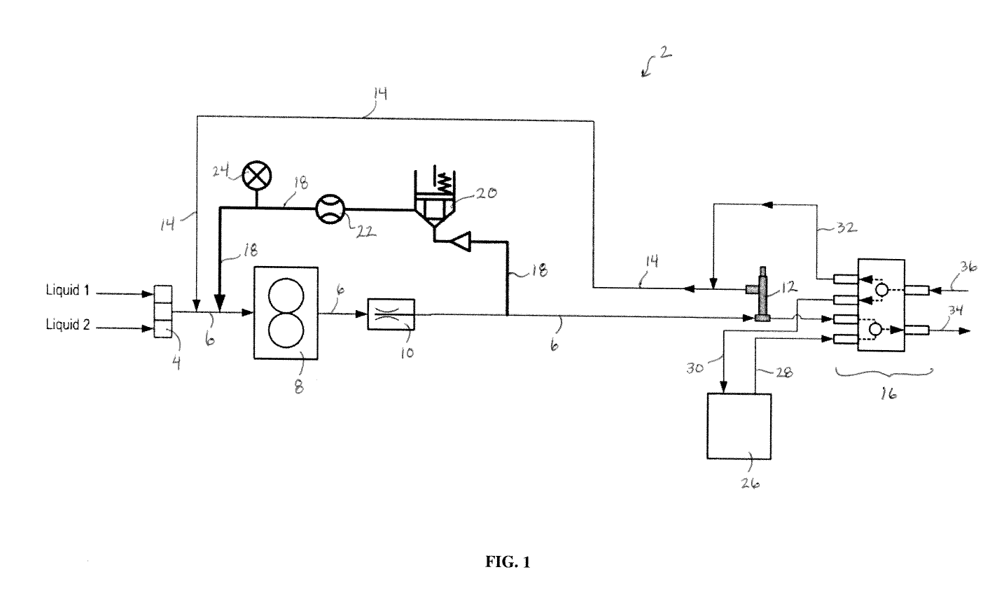

With reference to FIG. 1, emulsion-producing hydraulic circuit 2 includes intake port 4, supply line 6, pump 8, and emulsion-producing (or cavitation) device 10. Supply line 6 has a first and second end, with the first end of supply line 6 being connected to intake port 4 and the second end of supply line 6 being connected to fitting 12. Emulsion-producing hydraulic circuit 2 also includes return line 14 having a first and second end, with the first end of return line 14 being connected to fitting 12 and the second end of return line 14 being connected to supply line 6 (synchronous loop).

Hydraulic circuit 2 also includes by-pass loop 18 having a first and second end, both of which are connected, at separate locations, along supply line 6. Positioned in by-pass loop 18 is valve 20 and sensors 22 and 24.

Connected to hydraulic circuit 2 is distribution/selector manifold 16, which takes liquid fuel (in the form of an emulsion) from supply line 6 and, in the embodiment illustrated in FIG. 1, allows selection of a liquid fuel from alternative fuel source 26 delivered to the combustion site via fuel line 34. Mixed fuel from distribution/selector manifold 16 is then delivered to a combustion site via line 34. Return line 30 delivers unused fuel returned to distribution/selector manifold 16 via line 36 to either alternative fuel source 26 or return line 14 via line 32.

Hydraulic circuit 2 is a loop containing liquid, with by-pass loop 18 nested in the loop of hydraulic circuit 2. Thus, hydraulic circuit 2 is constructed of parts capable of containing and transferring liquid. In one embodiment, hydraulic circuit 2 is configured as a collection of connected tubes, hoses, pipes, etc. and fittings through which liquid flows. According to this embodiment, when it is said herein that lines or fittings are “connected,” it is understood that the connection is a connection suitable for transferring liquid throughout hydraulic circuit 2, or for transferring liquid into or out of hydraulic circuit 2.

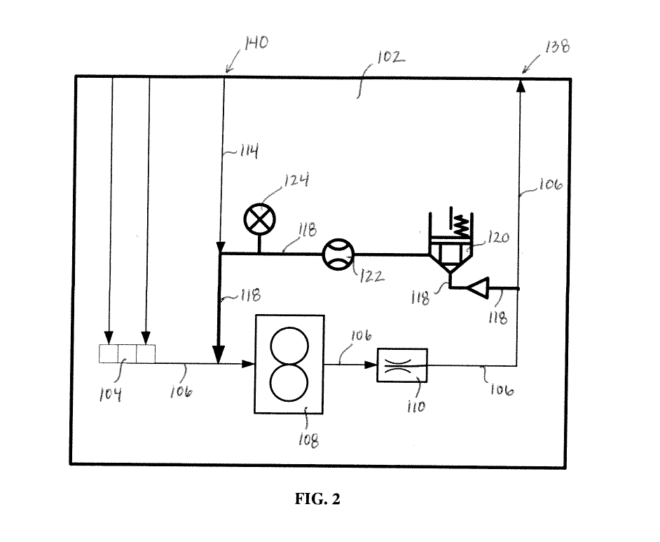

In an alternative embodiment, all or part of hydraulic circuit 2 resides in one or more blocks, and comprises a series of interconnected channels and devices. According to this embodiment, hydraulic circuit 2 may be formed in, e.g., a metal block or a block of material impermeable to water, as illustrated in FIG. 2 by block 102 (discussed in more detail below).

Referring again to FIG. 1, intake port 4 may take the form of various designs. In its simplest embodiment, intake port is a simple fitting for a liquid connector to permit a sealed flow of two or more liquids from one or more liquid sources into supply line 6 of hydraulic circuit 2.

Pump 8, according to one embodiment, is a gear pump, or any other type of pump capable of moving liquid through a hydraulic system. A gear pump uses the meshing of gears to pump fluid by displacement. Gear pumps are one of the most common types of pumps for hydraulic fluid power applications. Pump 8 creates necessary pressure in hydraulic circuit 2 to keep liquid flowing through the hydraulic circuit.

Emulsion-producing device 10 is a device capable of blending and emulsifying immiscible liquids and other substances. In one embodiment, emulsion-producing device 10 has a primary function of making droplets of discontinuous/dispersed substances in solutions small and to keep those droplets small by reducing surface tension and thereby slowing the droplet coalescence process. A person of ordinary skill in the art will appreciate that emulsion technology includes various devices and process for making emulsions by way of e.g., ultrasonic, mechanical, and hydrodynamic means. These methods include, for example, forcing flowing liquids and substances under pressure through flow redirection means which enhance fluid turbulence conditions. Turbulence, in conjunction with the resulting cavitation energy from a significant pressure drop, causes immiscible liquids (i.e., liquids that do not dissolve into one another) and/or contained substances to form a combined liquid emulsion or colloid.

Emulsion-producing devices typically constitute a means to achieve high-shear forces to impart high energy input into fluid streams and, more particularly, to mixing immiscible liquids and other substances to form emulsions through the use of controlled fluid turbulence and cavitation energy. Cavitation can be defined for purposes of this invention as the dispersing of a liquid medium into another liquid by creating excessive stresses. A suitable emulsion-producing device (or cavitation device) is described in PCT/US11/37004, filed 18 May 2011, which is hereby incorporated by reference in its entirety.

In one embodiment, the emulsion-producing device is a homogenizer or an adjustable homogenizer. Homogenizing involves transforming the chemical composition, appearance, and properties throughout a material. Homogenizers may utilize high pressure in the range of up to 200 atmospheres. Preferably, the homogenizer has the ability to control various cavitation, turbulence, flow, and pressure parameters in the cavitation chamber in order to produce a suitable emulsion, with suitable properties for the particular use being employed. Achieving desirable liquid emulsions or colloids depends on the ability to control and manipulate the droplet size of dispersed substances in solutions and create or maintain a stable solution in the presence of a wide range of emulsifiers.

Fitting 12 may be any fitting, but in one embodiment is a typical pressure relief valve capable of receiving emulsified liquid from supply line 6 and redirecting emulsified liquid to return line 14. Also, fitting 12 permits a draw of liquid from supply line 6 toward distribution/selector manifold 16 to supply, e.g., emulsified fuel to a combustion site. Alternatively, fitting 12 is constructed such that at least a portion of emulsified liquid from supply line 6 is diverted toward distribution/selector manifold 16 to provide, e.g., emulsified fuel to a combustion site.

In the embodiment illustrated in FIG. 1, distribution/selector manifold 16 selects emulsion fuel from supply line 6 or alternative fuel from alternative fuel source 26.

Valve 20, which is positioned in by-pass loop 18 is, in one embodiment, a cartridge needle valve. Other types of valves may also be used, so long as the valve is capable of adjusting the flow of liquid into by-pass loop 18.

Sensors 22 and 24, positioned in by-pass loop 18, are typically included to provide information about flow (i.e., volume) and pressure of liquid in by-pass loop 18. Sensors may also be positioned elsewhere in hydraulic circuit 2 wherever sensing is needed.

In the embodiment illustrated in FIG. 2, block 102 is drilled and/or tapped for hydraulic fluid flow and made into an emulsion manifold that includes intake port 104, supply line 106, pump 108, emulsion-producing device 110, return line 114, asynchronous by-pass loop 118, valve 120, and sensors 122 and 124. As illustrated in the particular embodiment of FIG. 2, supply line 106 leads to opening 138 in block 102, to which a pipe, hose, or channel is connected and which leads to opening 140 in block 102 to form return line 114. In the particular embodiment of FIG. 2, return line 114 connects to by-pass loop 118, which then connects to supply line 106.

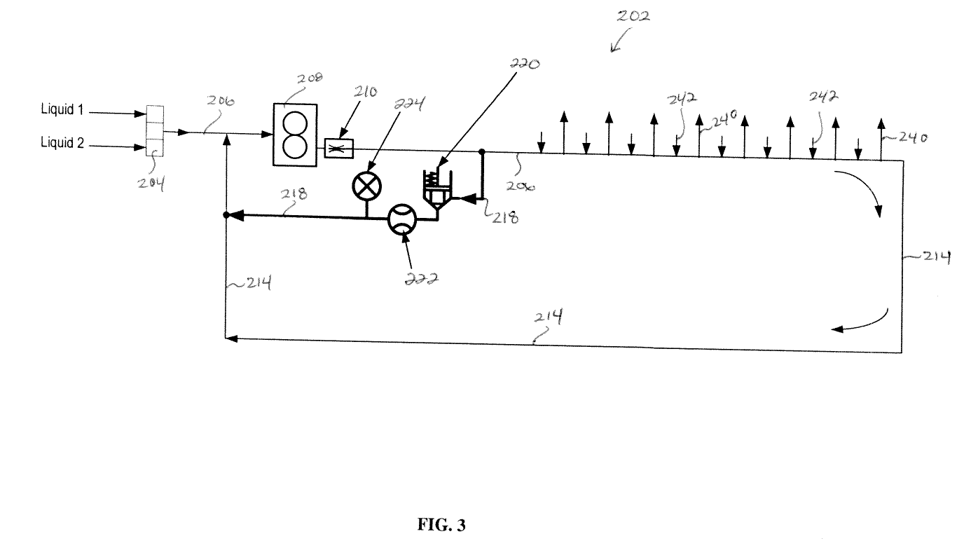

Turning now to FIG. 3, another embodiment of the emulsion-producing hydraulic circuit of the present invention is illustrated linked to a fuel rail in a diesel engine. As illustrated, emulsion-producing hydraulic circuit 202 includes intake port 204, supply line 206, pump 208, emulsion-producing device 210, return line 214, by-pass loop 218, valve 220, sensors 222 and 224, and exit lines 240 and return lines 242 to/from a fuel rail in a diesel engine.

With reference again to FIG. 1, in operation, hydraulic circuit 2 receives at least two liquids (or a single liquid mixture) through intake port 4 and into supply line 6. Thus, fluid to be emulsified in hydraulic circuit 2 enters via intake port 4 connected to supply line 6. Liquid in supply line 6 (and elsewhere in hydraulic circuit 2) is moved through hydraulic circuit 2 via pump 8 positioned in supply line 6. Pump 8 is constant volume, from which flow and pressure of liquid in hydraulic circuit 2 can be adjusted as necessary for any particular application.

In the embodiment illustrated in FIG. 1, emulsion-producing device 10 is positioned downstream of pump 8 and functions to create an emulsion of the mixed liquid contained in supply line 6 upstream of emulsion-producing device 10. An emulsion then flows from emulsion-producing device 10 further along supply line 6 to fitting 12, where the emulsion is delivered to or drawn by a combustion source, e.g., to be burned for fuel.

Hydraulic circuit 2 is a loop, so liquid flows from supply line 6 to return line 14, where it then re-enters supply line 6. By-pass loop 18 is a loop within the hydraulic circuit 2 loop. In other words, by-pass loop 18 has a first end and a second end, both of which are positioned along supply line 6, each at a different location before and after the pump along supply line 6. By-pass loop 18 is an asynchronous loop positioned in hydraulic circuit 2 to skim off a portion of any slug of water existing in hydraulic circuit 2 and to inject the slug of water (i.e., de-emulsified liquid) into supply line 6 to be re-emulsified. This asynchronous by-pass loop 18, which is nested within the normal supply/return line of hydraulic circuit 2, also serves as a redundant, or back-up, by-pass function, increasing pump seal protection as well as enabling asynchronous remixing of water back into an emulsion.

Fitting 12 is positioned in the loop of hydraulic circuit 2 to transfer (i) a first portion of the emulsion from hydraulic circuit 2 to a combustion site and (ii) a second portion of the emulsion to return line 14. Thus, fitting 12 can be used to regulate flow of emulsified liquid to a combustion site.

Liquid flow into by-pass loop 18 is controlled by valve 20. By-pass loop 18 is positioned in hydraulic circuit 2 to take/accept at least a portion of the emulsion and/or any separated liquid that has accumulated, e.g., during times of flow stoppage, in hydraulic circuit 2 to supply line 6. Thus, by-pass loop 18 functions to re-emulsify pockets of separated liquid that may accumulate in hydraulic circuit 2 via, e.g., gravity-induced separation, e.g., when hydraulic circuit 2 is inactive.

In one embodiment, hydraulic circuit 2 is capable of handling from 1 to 30 gallons per minute of liquid depending upon the design requirements and size of the combustion site.

Hydraulic circuit 102 of FIG. 2 operates in basically the same fashion as that described for hydraulic circuit 2 of FIG. 1 above.

With respect to hydraulic circuit 202 of FIG. 3, supply line 206 directly feeds exit lines 240, which are connected to a fuel rail in a diesel engine, and accept return fuel from intake lines 242, also directly connected to supply line 206.

Another aspect of the present invention relates to a method for re-emulsifying a separated liquid present in a hydraulic circuit. This method involves providing the hydraulic circuit of the present invention and opening the valve to permit flow of a portion of the emulsion and/or any separated liquid that has accumulated in the hydraulic circuit to the supply line to be re-emulsified.

The above description of embodiments of the present invention is merely exemplary in nature and, thus, variations thereof are not to be regarded as a departure from the spirit and scope of the invention.

What is claimed:

1. An emulsion-producing hydraulic circuit comprising:
an intake port for receiving at least two liquids;
a supply line comprising a first end and a second end, wherein the first end of the supply line is connected to the intake port to receive and transport the at least two liquids;
a pump positioned in the supply line to create flow of the at least two liquids through the hydraulic circuit;
an emulsion-producing device positioned in the supply line and capable of forming an emulsion of the at least two liquids;
a fitting connected to the second end of the supply line, wherein the fitting receives the emulsion and transfers (i) a first portion of the emulsion from the hydraulic circuit to a combustion site and (ii) a second portion of the emulsion to a return line, wherein the return line comprises a first end and a second end, the first end of the return line being connected to the fitting and the second end of the return line being connected to the supply line upstream from the pump; and
a by-pass loop comprising a first end and a second end, wherein the first end of the by-pass loop and the second end of the by-pass loop are connected to the supply line on either side of the pump, said by-pass loop further comprising a control valve, and wherein said by-pass loop transfers a portion of the emulsion and/or any separated liquid that has accumulated in the hydraulic circuit to the supply line to be re-emulsified.

2. The emulsion-producing hydraulic circuit according to claim 1, wherein the hydraulic circuit is formed in a single block manifold.

3. The emulsion-producing hydraulic circuit according to claim 1, wherein the at least two liquids comprise water and oil, and said emulsion is a water-in-fuel emulsion.

4. The emulsion-producing hydraulic circuit according to claim 1, wherein said pump is a gear pump.

5. The emulsion-producing hydraulic circuit according to claim 1, wherein said emulsion-producing device is an adjustable homogenizer.

6. The emulsion-producing hydraulic circuit according to claim 1, wherein said emulsion-producing device is positioned in the supply line between said pump and said fitting.

7. The emulsion-producing hydraulic circuit according to claim 1, wherein said combustion site is selected from a combustion engine, a turbine, and a burner assembly.

8. The emulsion-producing hydraulic circuit according to claim 1, wherein said by-pass loop further comprises:
one or more sensors.

9. The emulsion-producing hydraulic circuit according to claim 8, wherein said one or more sensors comprise one or both of a flow sensor and a pressure sensor.

10. The emulsion-producing hydraulic circuit according to claim 1, wherein said valve comprises a cartridge needle valve.

11. A method for re-emulsifying a separated liquid present in a hydraulic circuit, said method comprising:
providing the hydraulic circuit according to claim 1 and
opening said valve to permit flow of a portion of the emulsion and/or any separated liquid that has accumulated in the hydraulic circuit to the supply line to be re-emulsified.

12. The method according to claim 11, wherein the hydraulic circuit is formed in a single block manifold.

13. The method according to claim 11, wherein the at least two liquids comprise water and oil, and said emulsion is a water-in-fuel emulsion.

14. The method according to claim 11, wherein said pump is a gear pump.

15. The method according to claim 11, wherein said emulsion-producing device is an adjustable homogenizer.

16. The method according to claim 11, wherein said emulsion-producing device is positioned in the supply line between said pump and said fitting.

17. The method according to claim 11, wherein said combustion site is selected from a combustion engine, a turbine, and a burner assembly.

18. The method according to claim 11, wherein said by-pass loop further comprises:
one or more sensors.

19. The method according to claim 18, wherein said one or more sensors comprise one or both of a flow sensor and a pressure sensor.

20. The method according to claim 11, wherein said valve comprises a cartridge needle valve.
